(19) United States
(12) Patent Application Publication
(10) Pub. No.: US 2011/0197246 A1
(43) Pub. Date: Aug. 11, 2011

(54) Broadcast Media Management Router Video Server

(75) Inventors: Enzo Stancato, Trumbull, CT (US); Anthony Godfrey Nedd, Marlow Bottom (GB)

(73) Assignee: CYBER INTERNATIONAL TECHNOLOGY CORPORATION, Trumbull, CT (US)

(21) Appl. No.: 13/026,806

(22) Filed: Feb. 14, 2011

Related U.S. Application Data
(63) Continuation-in-part of application No. 13/001,132, filed on Feb. 14, 2011.

(30) Foreign Application Priority Data
Jun. 28, 2008 (IT) CS 2008 A 000016
Feb. 21, 2009 (IT) CS 2009 A 000005

(51) Int. Cl. H04N 7/173

(52) U.S. Cl. 725/111

(57) ABSTRACT

A multi wide area network (WAN) media content router, remotely controlled, and located from client reception stations, that enables video stream and multimedia content reception from terrestrial, satellite, internet protocol (IP) sources, 3G, and 4G. The router receives a plurality of direct transport streams from these different transmission media types without compression and routes these signals based upon predetermined protocol. The router receives multiple signals, discerns among the signals of different transmission media types, assesses the quality of the signals received, and delivers the highest quality signal to several multiplexed channels as an output in the form of a transport stream or packet data to a plurality of clients.

This application is a Continuation-In-Part of U.S. patent application Ser. No. 13/001,132 filed on Dec. 23, 2010, which claims priority to PCT/IT2009/000063 filed on Feb. 24, 2009, claiming priority from Italian Application Nos.: CS2008A000016, filed Jun. 25, 2008 and CS2009A000005, filed Feb. 21, 2009.

### BACKGROUND OF THE INVENTION

1. Field of the Invention

The invention relates to a media content device, which manages IP streams primarily with content serviced from major internet media-centers and broadcast streams from television service providers for consumption via local clients. The device also supports a secured remote content portal. Specifically, the media content device enables transport/program streams and multimedia content reception from terrestrial, satellite, and internet protocol (IP) sources. More specifically, the media content device receives a plurality of direct transport streams from these different transmission media and routes these signals based upon predetermined protocol. The media content device of the present invention may generally be referred to as a router, and shall henceforth be termed as such.

The router may be managed and controlled remotely, and is software configurable. It is capable of receiving multiple signals, discerning among the signals of different transmission media, assessing the quality of the signals received, and delivering several demultiplexed channels as an output in the form of a transport stream or packet data to a plurality of clients. The router is capable of selecting, controlling, recording, and delivering media content to multiple users over secure networking protocols.

2. Description of Related Art

Communication technologies for routing signals are well known. In many instances, a signal transmission is received and then routed through a local network with any number of “clients” or receivers connected. Communication networks enable client devices to communicate with one another on a global basis. Wired Local Area Networks (wired LANs), Wide Area Networks, and the Internet, all play a role in this communication scheme. Each of these networks is generally considered a “wired” network, even though some of these networks may include transmission paths that are serviced by wireless links. A number of signal sources are now available and widely used by the public, for example, WiMax, 3G, 4G, Digital Subscriber Line, cable, optic fiber, digital satellite TV, digital terrestrial TV, and digital/analog cable TV, to name a few. Wireless networks have been in existence for a relatively shorter period of time. Cellular telephone networks, wireless LANs (WLANs), among others, are examples of wireless networks.

There are many issues that derive from trying simultaneously to engage, transmit, and/or receive, multiple signal and network types currently available in the marketplace. The quality of the video or data signal, the type of signal, and the selection of the different signal types makes any implementation of a multiple signal platform technologically difficult. Users are generally not in a position to determine which of various networks are actually available, will yield the best signal quality, and/or be most cost-effective at a particular time. Users may not have access to, or be aware that they may have access to, a plurality of transmission media. In this regard, it is desirable to have a device for the acquisition and distribution of various types of digital content, media, and/or entertainment, simultaneously. One such device capable of receiving signal content and directing the signal content to specific clients is a router.

Generally, a router distributes digital computer information contained within a data packet. Each data packet contains address information that a router can use to determine if the source and destination are on the same network, or if the data packet must be transferred from one network type to another. This transfer to another type of network is achieved by encapsulating the data with network specific protocol header information. Additionally, when a given packet is transferred to a network port, the router alters information in the packet header. This altered packet header information is then used by downstream network devices, including other routers to determine if a transfer is required. When multiple routers are used in a large collection of interconnected networks, the routers exchange information about target system addresses, so that each router can build up a table showing the preferred paths between any two systems on the interconnected networks.

A router generally has an interface connection for a single, given network transmission (such as copper cables, fiber optic, or wireless transmission). It will generally contain firmware for receiving and handling different network protocol standards. Each router is specialized to convert signals from one protocol standard to another. Thus, for example, a router capable of receiving wireless communication may transmit this information via cable to a receiving device.

In the US, multiple digital signals are combined and then transmitted from one antenna source to create over-the-air (OTA) broadcasts. By the reverse process, a receiver may first receive the combined transport stream and then decode it to display one of its component signals on a remote device, such as a computer or TV set. In principle, more than one signal within the same transport stream could be decoded by one receiver and displayed on multiple TV sets or as picture-in-picture on a single set, with only one selective tuning and demodulation block.

Since digital signals that are broadcast over-the-air are compressed (packed smaller) once they are received by a tuner, these compressed packets of digital data must then be reassembled and then decompressed (unpacked to their original size or converted into the required size for further use). In general, systems employ lossy compression, so while the decompressed data size is the same as the original uncompressed data size, the data produced is not exactly the same as the original data fed into the system at the transmitting site, but it is close enough that most people do not notice much degradation in the picture and sound. It would be beneficial, however, to be able to transport a stream of data without compression, and eliminate the loss in signal quality.

A transport stream is a standard format for transmission and storage of audio, video, and data, and is used in broadcast systems such as DVB and ATSC. A transport stream specifies a container format encapsulating packetized elementary streams with error correction and stream synchronization features for maintaining transmission integrity when the signal is degraded. Depending upon the transmission method, one or more program streams are carried within a transport stream.

The Transport Control Protocol/Internet Protocol (TCP/IP) has been widely used in today's Internet technology. A TCP/IP-based Internet provides a datagram transmitting system between network devices such as hosts and servers connected to an Internet.

Digital signal compression involves a process for encoding digitized audio and/or video signals so that the amount of information transmitted can be increased and carried on a lower-capacity communications system, taking up less storage and requiring less bandwidth for efficient transmission. In this manner, digital signal compression increases a system's channel capacity.

Home wireless routers typically couple to the Internet via a cable modem or other broadband connection. The cable modem network capacity, however, is shared by a relatively large number of users and the availability of capacity to service communications between the home wireless router and the Internet varies over time. Moreover, the wireless routers available in the marketplace do not have the versatility or capability of receiving multiple transmissions from distinctly different sources (WiMax, 3G, 4G, Broadband Internet (DSL, cable, optic fiber), satellite TV, digital and analog TV, and cable TV) simultaneously, while being capable of making predetermined transmission decisions based on the different signal qualities received, including but not limited to: from a broadcast station with a smart server and software selecting the best transmission signal for the best bandwidth needed for high quality media content delivery.

### SUMMARY OF THE INVENTION

Bearing in mind the problems and deficiencies of the prior art, it is therefore an object of the present invention to provide a router that represents a complete internet distribution center, and is capable of supporting a plurality of connection formats, such as WiMax, DSL, 3G/4G, and the like.

It is another object of the present invention to provide a router that utilizes digital terrestrial, satellite, and digital/analog cable signal decoders, allowing clients to receive any one of these signals without possessing its own client decoding hardware.

A further object of the invention is to provide a router capable of differentiating and qualitatively measuring various types of signal inputs, discerning among these signal inputs for the best transmission signal or combining multiple signal paths and load balancing, and delivering the best transmission signal to a client user.

Another object of the present invention is to provide a versatile router capable of a plurality of transmission and reception technologies to ensure global reach for clients where signal quality is poor due to limited service and/or limited providers.

The above and other objects, which will be apparent to those skilled in the art, are achieved in the present invention which is directed to a router for simultaneously receiving and routing digital terrestrial, internet, satellite, and cable signal transmissions, comprising: a first antenna embedded within the router, designed to receive and be in communication with digital terrestrial signal transmissions, and capable of receiving power from an internal power supply via a signal path; at least one second antenna embedded within the router, designed to receive and be in communication with wireless internet source transmissions; an electrical or optical cable interface designed to receive and be in communication with cable TV signal transmissions; a wireless or electrical cable interface designed to receive and be in communication with satellite signal transmissions; a broadband modem, which may be embedded, for receiving and being in communication with DSL and cable transmission signals; a processor for determining the quality of each signal received by the router, selecting a highest quality signal, and allowing for the transmission of the highest quality signal to a client requesting the signal; a plurality of embedded Local Area Network communication devices for transmitting routed signals to end users; and an embedded wireless transmission device for transmitting routed signals to end users.

The router may further include: a first signal multiplier for receiving and multiplying the cable TV transmission signal into N₁ cable TV transmission signals; a first set of decoders corresponding to and in electrical communication with the N₁ cable TV transmission signals; a second signal multiplier for receiving and multiplying the satellite transmission signal into N₂ satellite transmission signals; a second set of decoders corresponding to and in electrical communication with the N₂ satellite transmission signals; a third signal multiplier for receiving and multiplying the digital terrestrial signal transmissions into N₃ digital terrestrial signals; a third set of decoders corresponding to and in electrical communication with the N₃ digital terrestrial signals; and an IP Decoder Interface Manager in electrical communication with an output of each decoder in the first, second, and third sets of decoders.

The wireless internet source transmissions may include WiMax, Wifi, 3G, and 4G, or any combination thereof. The at least one second antenna preferably includes embedded antennas for receiving signal transmissions in WiMax, Wifi, 3G, and 4G, or any combination thereof.

In a second aspect, the present invention is directed to a transmission signal routing system for a client/server configuration comprising: a router for simultaneously receiving and routing internet, satellite, and cable signal transmissions, the router in direct communication with at least one server device; the at least one server device configured to manage transactions and communications with a plurality of client devices; the router comprising: a first antenna embedded within the router, designed to receive and be in communication with digital terrestrial signal transmissions; at least one second antenna embedded within the router, designed to receive and be in communication with wireless internet source transmissions; an electrical or optical cable interface designed to receive and be in communication with cable TV signal transmissions; a wireless or electrical cable interface designed to receive and be in communication with satellite signal transmissions; a broadband modem for receiving and being in communication with DSL and cable transmission signals; a processor for determining the quality of each signal received by the router, selecting a highest quality signal, and allowing for the transmission of the highest quality signal to a client requesting the signal; a plurality of embedded Local Area Network communication devices for transmitting routed signals to the at least one server device and some or all of the plurality of client devices, or any combination thereof; and an embedded wireless transmission device for transmitting routed signals to the at least one server device and some or all of the plurality of client devices, or any combination thereof. The router may direct media transport streams directly to the at least one server device.

In a third aspect, the present invention is directed to a method of receiving and routing broadcast transmission signals comprising: simultaneously receiving digital terrestrial signal transmissions, wireless internet source transmissions, digital terrestrial source transmissions, cable TV signal transmissions, and satellite signal transmissions in a single router device: determining the quality of each signal received; selecting a highest quality signal for each TV channel, or any other functions, such as video conferencing, video surveillance, VOD, and the like, selected by an end user; and transmitting the highest quality signal, from the simultaneous reception of multiple transmission sources, to the end user requesting the channel, the transmitting performed by sending the end user the highest quality signal via embedded Local Area Network communication devices or via embedded wireless transmission devices. This method may include: multiplying the digital terrestrial signal transmissions, wireless interne source transmissions, cable TV signal transmissions, and satellite signal transmissions, or any combination thereof, each into a plurality of signal sets; sending the plurality of signal sets to individual decoders corresponding to individual signals of the plurality of signal sets; managing outputs of each of the individual decoders using an IP Decoder Interface Manager, the IP Decoder Interface Manager responsive to the selection of the highest quality signal for each channel selected by an end user; and transmitting the highest quality signal for each channel selected by an end user via the embedded Local Area Network communication devices or via the embedded wireless transmission devices.

The method may further include continuously determining the quality of each of the signals received while the highest quality signal for each channel selected by an end user is being transmitted, and seamlessly substituting a new highest quality signal for a previous highest quality signal to the end user without interruption of the signal.

In a fourth aspect, the present invention is directed to a method for addressing signal integrity of a router connected to a network, the method comprising: initiating an area network status test by sending a ping-type data packet to at least one receiving device; checking for acknowledgement of the ping-type data packet from the at least one receiving device; reporting if the acknowledgement is not received; setting at least one counter of no acknowledgement; re-initiating the status test by resending the ping-type data packet to the at least one receiving device; and if the at least one counter exceeds a predetermined limit of receiving no acknowledgement, initiating a communications protocol restart of the router and resetting the at least one counter to zero.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts an operational schematic of the remote controlled video and internet router of the present invention.

FIG. 1A depicts the intelligent selection path performed by the router of the present invention.

FIG. 2 depicts a detailed internal structure of the router of the present invention.

FIG. 3 depicts a client/server (master/slave) configuration utilizing a router of the present invention.

FIG. 4 depicts a connectivity and logic decision schematic of the router of the present invention within a WAN/LAN configuration.

FIG. 5 depicts the router of the present invention with wireless and digital terrestrial antennas mounted therein.

FIG. 6 depicts a perspective exploded view of the backside of the router of FIG. 5.

FIG. 7 depicts an optional embodiment of the present invention that incorporates board integrated amplified digital terrestrial antennas for UHF and VHF.

FIG. 8 is a perspective exploded view of the backside of the router of FIG. 7.

### DESCRIPTION OF THE PREFERRED EMBODIMENT(S)

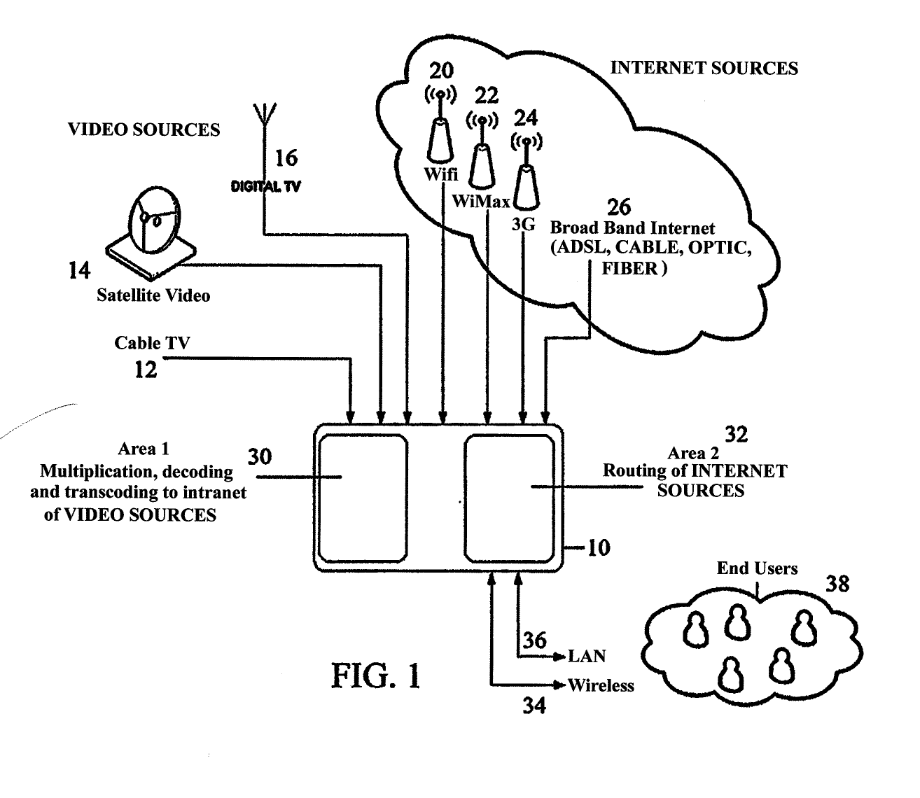

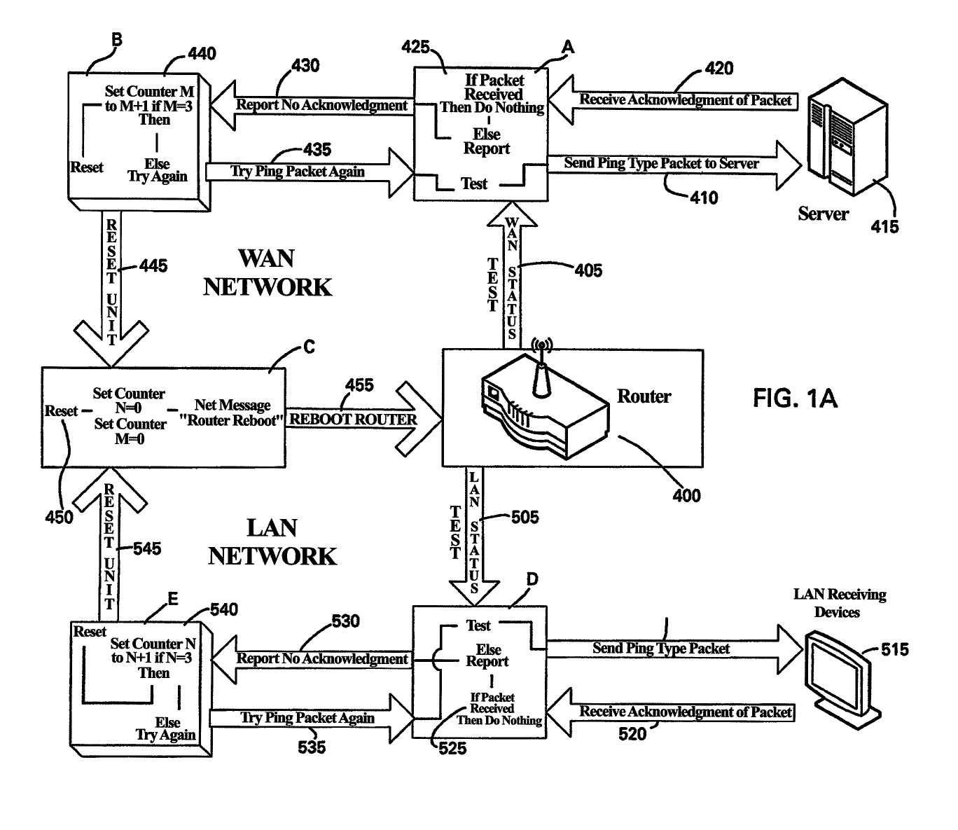

In describing the preferred embodiment of the present invention, reference will be made herein to FIGS. 1-8 of the drawings in which like numerals refer to like features of the invention.

The remotely controlled internet and satellite signal router of the present invention is designed to be a central device for media distribution, where clients may access broadband internet services or access one of many multiplexed channels, by commanding internal decoders within the router. The router may be designed to accommodate a plurality of channels (decoders) as desired without altering its basic operational principle, which involves the inclusion of remotely commanded demultiplexers for as many channels as predetermined. It allows for a plurality of clients without having to install expensive decoders and associated hardware.

The router of the present invention is designed to accommodate and acquire video and multimedia transmission streams from a plurality of independent sources simultaneously, including terrestrial, satellite, cable, and IP TV streams, such as WiMax, 3G, 4G, satellite, DSL, digital satellite TV, digital terrestrial TV, and digital/analog cable TV, to name a few, and is capable of transporting this information as selected to local environment clients. The router can also simultaneously accommodate individual independent sources of media content delivery. Electronic storage may also be provided for later retrieval and subsequent transmission to both local and remote sites.

The router of the present invention is preferably configured to receive video content (satellite, cable, and digital TV) simultaneously for distribution on the local intranet to clients. The video content is preferably available from multiple sources. The router multiples the signals it receives and sends the multiplied signals to individual decoders within the router. The decoders then transcode the video content in a compatible digital format for transmission via an intranet network.

Importantly, the router receives and transmits stream and packet data of video and audio signals, and is able to transmit the packet data and/or the entire stream to any computer or receiving device (e.g., electronic or mobile receiver) on the operating system. For transport streams, the router is tuned to a particular transponder via an antenna link, or Wifi/WiMax, or other air-to-air transmissions, and acquires the transport stream from the antenna. In this manner, all necessary signal information is acquired at the router. Each channel is delivered to each client at a time through the multiplexed scheme.

FIG. 1 depicts an operational schematic of the remote controlled video and internet router 10 of the present invention. Router 10 is configured to receive transmission signals from a plurality of sources including digital/analog cable TV 12, digital satellite video 14, digital terrestrial TV 16, Internet sources 18 such as Wifi 20, WiMax 22, 3G/4G 24, and broad band internet 26 including DSL, cable, and optical fiber. One portion 30 of router 10 includes electronic and software for multiplying, decoding, and transcoding the input source signals to the intranet. A second portion 32 of router 10 serves to route the internet sources. Router 10 is designed to transmit and receive information from wireless networks 34 and local area networks 36, which in turn, communicate with the end users 38. This allows end users 38 to communicate with router 10 and select channels for viewing, while allowing router 10 to transmit the selected channel to the client.

The remotely controlled video and Internet router is software configurable to receive input from internet connection, digital satellite TV, Digital Terrestrial TV, and digital/analog cable TV, and distribute these signals to multiple clients. Router 10 is configured via hardware and software to receive the multiple signals, measure the quality of each signal (compare and contrast), and upon client request for a specific channel, select the best signal of that channel to transmit to the client while periodically testing signal quality to maintain optimum signal performance to the client based upon internal empirical measures. A logical flow chart of this methodology is presented in FIG. 1A as a selection path.

FIG. 1A depicts the intelligent selection path performed by the router of the present invention. In this selection path, the user initiates the process by selecting, for example, a video (e.g., TV) program 1000. The main electronic program guide data base is then checked 1010 for the various locations of the video program. This check is preferably performed via the internet 1015. The router then selects the primary transmission source (deliverer) for the video acquisition 1020 based on a quantitative measure of the ability to deliver a quality signal. This selection is made from available sources capable of transmitting the selected video. Such sources include 3G/4G/WiMax IP Video Connections 1025, Digital Terrestrial transmissions 1030, digital/QAM/Analog Cable 1035, digital satellite 1040, and a plurality of wide area networks 1045a-b, or any combination thereof A secondary transmission source is then determined 1020, if one exists, or if an IPTV 1050a-b selects an additional transmission. The primary selected transmission source signal is then fed to the IPTV 1050a-b and/or standard broadcast TV 1055 devices for ultimate display at the user end 1060a-c. Upon a determination that the quality of the primary transmission source signal has degraded below the quality of a secondary transmission source signal, the secondary transmission source signal is then substituted for the primary transmission source signal in a preferably seamless manner such that the client/end user viewing is uninterrupted, and the client/end user is unaware that any signal substitution was actually made. The signal quality may be measured in numerous quantitative determinations, including, but not limited to, an investigation of signal amplitude, frequency, bandwidth, propagation velocity, distortion, rise/fall times, to name a few, and any combination thereof. In a preferred embodiment, the router of the present invention makes this signal quality determination periodically throughout the time the transmission source signal is being delivered. A new secondary transmission source signal may be substituted anytime the most recent allocated primary transmission source signal has been deemed deficient based on the signal quality metrics. In this manner, the user selected video program is delivered by the most reliable, and in some instances multiple, paths.

The satellite signal is multiplied many times and sent to a number of internal decoders. In this manner, the router receives a satellite signal and may output several demultiplexed satellite channels or a complete transport stream. The router is remotely controlled by the clients, who ultimately decide which channels shall be demultiplexed either locally or within the client.

Clients interfacing with the router of the present invention are able to query the router and control video streams via a set of IP commands.

Router 10 also includes a system that protects it from external agents. An external agent resistant enclosure and back ports protects the router from environmental elements and other infiltrations by extending the enclosure around the ports with an environmental safety cover. Thus, router 10 is versatile enough to be stationed and operable in an area exposed to outside environmental conditions.

Allowing router 10 the capability of being stationed outside enables the router to obtain solar power for its operation. In one embodiment, sides of router 10 may be covered with solar panels. With power storage, the solar panels can guarantee continuous function even in the event of an electrical outage. The power storage system (UPS) is preferably configured with a battery that can be recharged by both the main power (when available) and the solar panels.

In order to communicate with different signals, router 10 is configured with multiple antennas, such as satellite and digital terrestrial. Terrestrial TV, which is associated with and/or known as, Free-to-air-TV, Free-to-air Digital Television, Digital Terrestrial Television (DTTV), to name a few, is generally television transmission using one or more transmitters that are located on the ground. Analog television was initially transmitted via terrestrial transmission. Digital terrestrial TV (DTTV) is transmitted on radio frequencies through terrestrial space in the same way as standard analog television, with the primary difference being the use of multiplex transmitters to allow reception of multiple channels on a single frequency range (such as a UHF or VHF channel). Similarly, Digital Terrestrial Broadcasting (DTB) can be received anywhere and at anytime with a small reception antenna. The router of the present invention is designed to be expandable to accommodate Digital Terrestrial Bandwidth, when and where this technology is available.

Via DTB, end-users (customers) can watch programming and receive other data that has been transmitted to compatible wireless devices. These signals may be received via a digital set-top box, or preferably via an integrated receiving device that decodes the signal received via a standard aerial antenna. However, due to frequency planning issues, an aerial capable of receiving a different channel group (usually a wideband) may be required if the DTTV multiplexes lie outside the reception capabilities of the originally installed aerial.

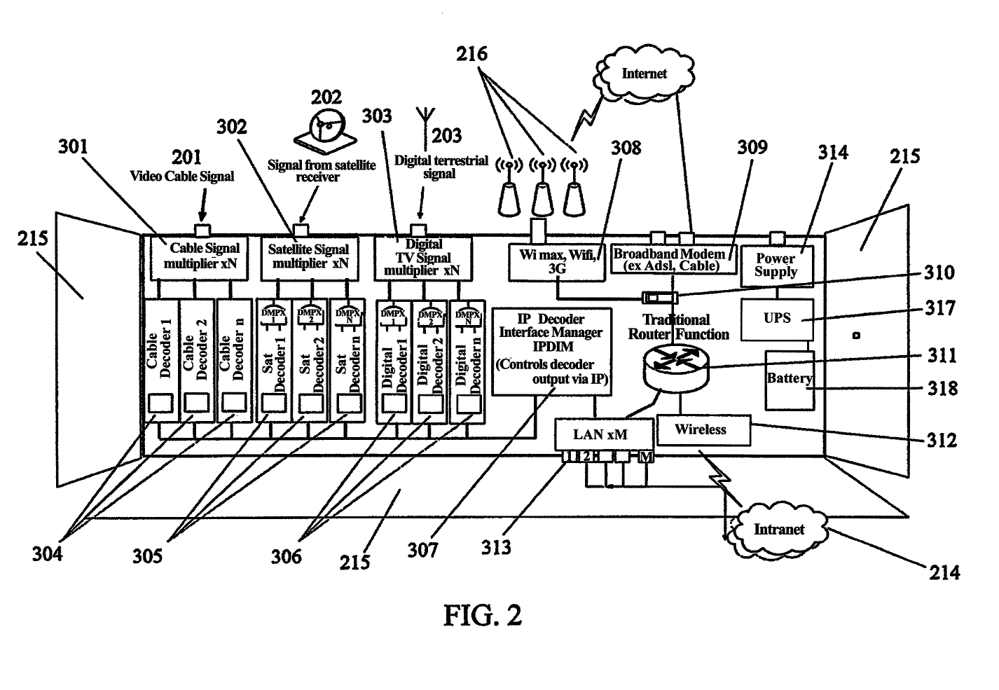

FIG. 2 depicts a detailed internal structure of router 200 of the present invention. A video cable signal 201 is received by a cable signal multiplier 301, which is preferably configured as an n-times multiplier. Each multiplied signal is transmitted to an individual decoder. Similarly, a signal transmitted via satellite to digital satellite receiver 202 is received by a satellite signal multiplier 302, which also preferably configured as an n-times multiplier, sending each multiplied signal to its own decoder. The multiplexed video cable signals are transmitted internally to individual cable signal decoders 304, while the multiplexed satellite signals are transmitted internally to individual satellite signal decoders 305. The number of decoders is not limited, and may be extended based on predetermined system configuration requirements. The received signals are decoded, demultiplexed, and individually sent to an IP decoder interface manager 307, which controls the decoder outputs via internet protocol.

Router 200 is designed to distribute internet and a plurality of satellite channels to a plurality of clients. Each client may receive many different digital satellite streams.

The communication between clients and router 200 may be via internal LAN 313 and may not necessarily require an internet connection. Router 200 is preferably configured with multiple available internal decoders, each one of which may be remotely programmed by the clients with the commands available and defined by the internal protocol of router 200.

Essentially, router 200 receives multiplexed signals from TV, Internet, and media servers, and multiplies these signals n times, transmitting each of the n signals to corresponding internal decoders. Preferably, these decoders are commanded via IP by client devices, so that they are capable of selecting, receiving, and transmitting any given channel that the client device requests.

The decoders are piloted via an external interface, preferably via IP commands. The client boxes access one of the decoders (a non-utilized one) and transmit information regarding which channel is to be decoded by that particular decoder. The IP interface is programmable and has a predetermined user interface. Router 200 is programmable, transmitting and receiving information from externally connected devices, and designed to provide software verifiable commands such as: a) decoder busy (true/false); b) decoder/channel ID (number, channel selected); c) change channel (decoder, channel); d) free decoder (decoder number); and e) reset (decoder number), to name a few.

Other possible decoder functions are preferably implemented via software interface. The integrated software that provides the interface for router 200 is preferably served by the same gateway address.

DTTV (digital terrestrial) signals 203 are received internally by a Digital TV signal multiplier 303, which is preferably configured as an n-times multiplier. The multiplexed signals are transmitted internally to individual Digital TV signal decoders 306 that are then decoded and individually sent to IP decoder interface manager 307. In the present invention, the digital terrestrial antenna is preferably embedded within the router as part of the internal router hardware with electric power to the antenna supplied by the RF antenna signal path. This configuration eliminates a separate power cord to the digital terrestrial antenna. In at least one preferred embodiment, other antennas in addition to the digital terrestrial antenna, such as WiMax, Wifi, and 3G antennas, as well as wireless broadband antennas, are embedded within router 200, with the goal an embodiment to incorporate as many antennas internally to the router as current technology will allow. In another preferred embodiment, a signal tuner is embedded within the main board of router 200.

Furthermore, in order to integrate a TV antenna within the router enclosure, a reduction in antenna circuitry topology was necessitated that ultimately included an electronically controllable variable gain amplified antenna.

IP decoder interface manager 307 comprises an integrated circuit set of devices for controlling via IP, digital/analog cable signals 201, digital satellite signals 202, and digital terrestrial TV signals 203. IP decoder interface manager 307 allows the device to be controlled via Internet protocol by the clients it is serving. Consequently, router 200 is configured to receive via IP, commands from the clients, and to take instructions from these commands for routing the associated, selected signals.

Wireless input, such as Wifi, WiMax, 3G, 4G, and any future wireless protocol, are received by antenna 216 and routed via traditional routing functional hardware 308, 310, 311 to multiple Local Area Network (LAN) intranet connectors 313, and wireless intranet communication 312 for intranet communication 214. Connectivity selector 310 selects the signal to be routed. This selection may be made manually or automatically. In at least one preferred embodiment, a plurality, if not all Wifi, WiMax, 3G, and 4G antennas are embedded in router 200.

Broadband modem interface hardware (cable, ADSL or any future non-wireless technology) may also be accommodated with signals received via the Internet. A broadband modem 309 is preferably integrated within router 200, and routed through traditional routing functional hardware 310, 311.

Three sides 215 of router 200 are preferably solar panels for economical preservation of power. Power supply 314, UPS 317, and battery 318 form the power supply network for router 200, and work in concert with solar panels 215. The UPS circuit 317 and battery 318 maintain functionality during electrical outage conditions. This configuration accommodates exposing router 200 to environmental conditions.

Router 200 performs the traditional functions of a router in addition to the tasks delineated above. One primary function is to distribute harmoniously all channels and bandwidth. As depicted in FIG. 2, router 200 consists of a traditional WiMax or broadband input and an internal router with outputs, to provide connections to all the client boxes on the network. Router 200 also possesses unique satellite decoding capabilities as well.

Under the router configuration of the present invention, it is possible for clients to change the channel of a decoder, to have absolute privileges on a decoder, to free decoders, or any combination thereof. These client commands facilitate the external management of router 200.

Typical external commands that router 200 is designed to accommodate include the following:

a) change channel (demultiplex) the decoder number X to channel Y;

b) get absolute privileges on the first free decoder, and return the allocated channel;

c) request an occupied decoder, that is, if all the internal decoders are occupied, a request may be made for an occupied decoder to another router box, which may then decide if it will allocate a decoder;

d) free a decoder currently occupied by the client;

e) sends a message to the client when a decoder is free;

f) status the decoders and let users know if the decoder number N is free; and

g) provide a new address for the client (reset function).

Router 200 may be placed in the vicinity where clients are located. One advantage is that it functions for each client as a complete internet distribution center and is capable of supporting various types of connection inputs and outputs (WiMax, 3G, 4G, LAN, DSL, and the like). It allows for the efficient use of satellite decoders, allowing clients to have an internet input, without the need of possessing their own decoding hardware. Thus, router 200 helps reduce the cost of multimedia content for each client that seeks to receive internet transmissions. One ideal location for the router of the present invention to be utilized is in a gated community that is in need of, in some way, a cost-effective, versatile media distribution system.

The core processing of router 200 preferably utilizes a single or several high performance ARM processor(s) or the like to control high performance IP routing and transport stream acquisition hardware. An ARM processor is any of several 32-bit RISC (reduced instruction set computer) microprocessors. The ARM architecture has evolved into a family of microprocessors extensively used in consumer electronic devices such as mobile phones, multimedia players, pocket calculators, and personal digital assistants (PDAs).

ARM processor features include: Load/store architecture; an orthogonal instruction set; mostly single-cycle execution; a 16×32-bit register; and enhanced power-saving design. Currently, the ARM architecture is the most widely used 32-bit ISA in terms of numbers produced The core ARM code will facilitate the following functions:

a) the control and operation of individual transport stream access devices;

b) the management of all channel access and routing control;

c) seamless selection and control of media onward delivery transport channels;

d) arbitrating and maximizing channel efficiency and throughput capacity;

e) selection of IP program content or multiple broadcast stream sources at the command of remote clients, and onward routing to the requesting user;

f) management of channel load sharing and redundancy fall back;

g) aggregation of channels to facilitate higher throughput channels where required;

h) provisions for security for both client and system access, as well as stream data security, such as DRM management; and

i) provisions for a commercial portal to facilitate secure purchase and commercial promotion.

The router of the present invention is designed to accommodate multiple media transport stream access for all multimedia broadcast systems, including ATSC, Clear QAM, DVB-T, DVB-T2, DVB-S, DVB-S2, DVB-C, DVB-C2, ISDB, analog cable, worldwide analog TV, and IPTV, and the like. It is capable of accommodating future multimedia technology as well.

Furthermore, router 200 is designed to accommodate Local Area Network interfacing for current and future IP connectivity media including Wireless LAN 802.11a/b/g/n, and all Wired LAN 802.3x implementations. WLAN throughput is preferably optimized using Multiple In-Multiple Out antenna and transmission technology.

Wide Area Network interfacing is designed within router 200 for all current WAN connectivity methodology, including Cable modem, DSL modem, WiMax modem, Satellite modem, and high speed mobile 3G/4G modem, and the like.

In one preferred embodiment, router 200 includes a SATA interface for hard disc drive usage or for other storage media, which enables storage and recording of transport/program streams for future recovery. This also facilitates automatic stream buffering for rewind or stream recovery in the event of user satellite station downtime.

Debug, diagnostic, programming and field maintenance facilities are implemented in router 200 using USB, JTAG, and secure access IP routes. A dedicated master Real Time Clock facility is provided to ensure system security and time management at all times and in the event of power failure. UPS and Battery back-up is provided for maintenance of service during power blackouts. The Real Time Clock also facilitates signal synchronization.

The preferred embodiment of the router of the present invention is currently capable of supporting as many as twelve (12) independent broadcast channels, with hardware and software capability for further expansion.

Router 200 is a multifunctional telecommunication apparatus, implemented in a single box, having the ability to connect to any type of display, including CRT, LCD, or plasma.

The router is, above all, an advanced, specialized computer for routing and video serving that contains within it a variety of functions with consequent energy savings. Unlike existing television technology systems that exhibit a high consumption of energy because they are inclusive of a television and various other power consuming technological devices, for example, a DVD player connected to a TV, plus a PC connected to the Internet. In the present invention, router 200 allows for all such options and extra multimedia functions to be available through a single device that is capable of functioning as a transmitter/receiver signal catalyst.

As noted above, router 200 may also be utilized in a client/server or master/slave configuration, which is, for example, suitable for hotels and similar multi-use operations. Hotels, having a substantial number of rooms, can use a client device or box for each room which has lower performance to the master or server device, but sufficiently satisfactory performance for the use of the customer or client. The server device manages transactions and communications of the client device. The server device is the server for administration of its associated client boxes. In such configurations, it uses an ad hoc system that allows communication and controls the operations of the client boxes, using databases constantly updated according to type of contract selected by the client.

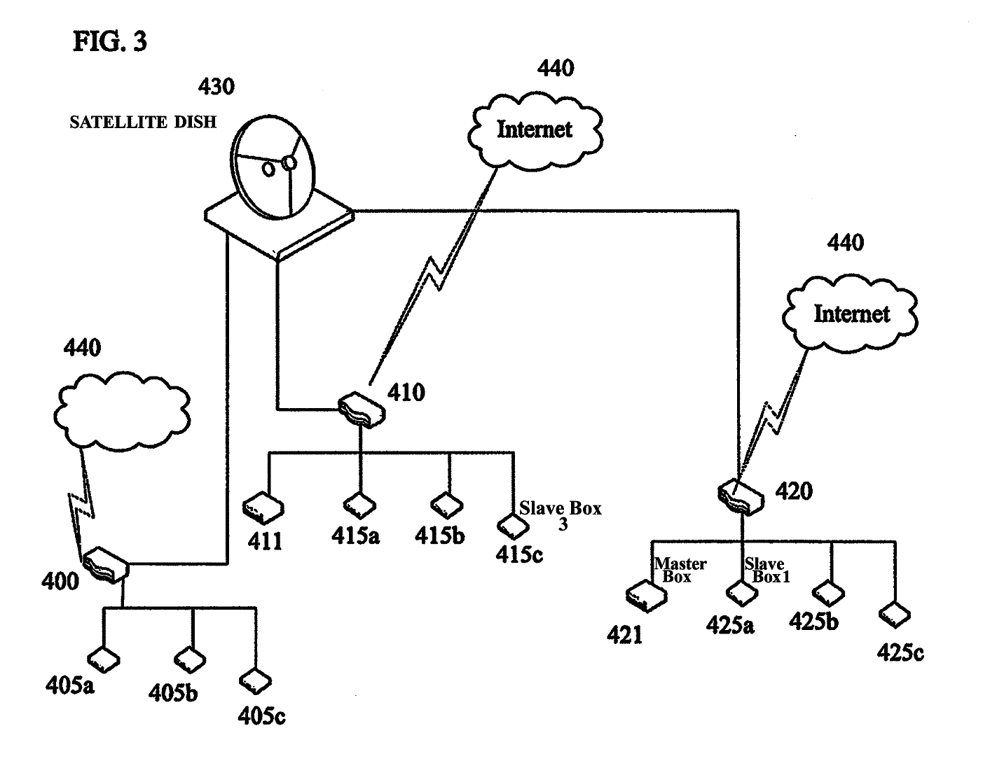

FIG. 3 depicts a client/server (master/slave) configuration utilizing a router of the present invention. Routers 400, 410, and 420 are connected to a satellite dish 430 and via the Internet 440. Each router is in direct communication with either a client/server configuration or a configuration where it is in direct communication with client devices. Router 400 communicates directly with client devices 405a-c. Router 410 communicates with server or master device 411 and client devices 415a-c. Router 420 is depicted communicating with master device 421 and client devices 425a-c. Each server or master 411, 421 controls all the external traffic between any corresponding clients. Only the video streams in large data packets go directly to the client (after requesting and receiving permission from the server). This function is performed as a way not to overload the server, considering that the quantity of client boxes could be significant. The average client box allows a partial, but effective use of the service available through the router. For example, in the event that all users are viewing a single video stream at a time (a popular video or event), the client box is precluded from handling multi-video or full multi-processing, in contrast to a non-client configured device. This limited operation is still amply sufficient for a client desiring to view, for example, a TV program, or go on the interne or buy on demand.

The client device is less complex than the server or master device, and therefore a more cost effective device to be employed in large quantities. Essentially, it does not have as extensive complex hardware/software, and performs fewer functions. It has a processor, motherboard, and video card with considerably lower performances than the master device. In this manner, it is considerably smaller in size, and made to be available at a considerably lower cost than the master client. Importantly, the client device maintains technology to ensure excellent communication and interaction with a specialized system, such as the hotel client/server (master/slave) configuration identified above. In this configuration, the master device is the true server. It has a far more complex structure than that of the client device, but still lowers the cost of implementing a router in each hotel room insomuch as the master device only has to manage data, and in some instances, report purchases made by the client box. It is not required to perform the entire workload of the client devices, working only as a control system and database, authorizing the client device to perform a requested operation. The structure of the master is very similar to the router structure, without the higher performance hardware, associated embedded antennas, multiplexing and demultiplexing, and associated supporting software for these functions.

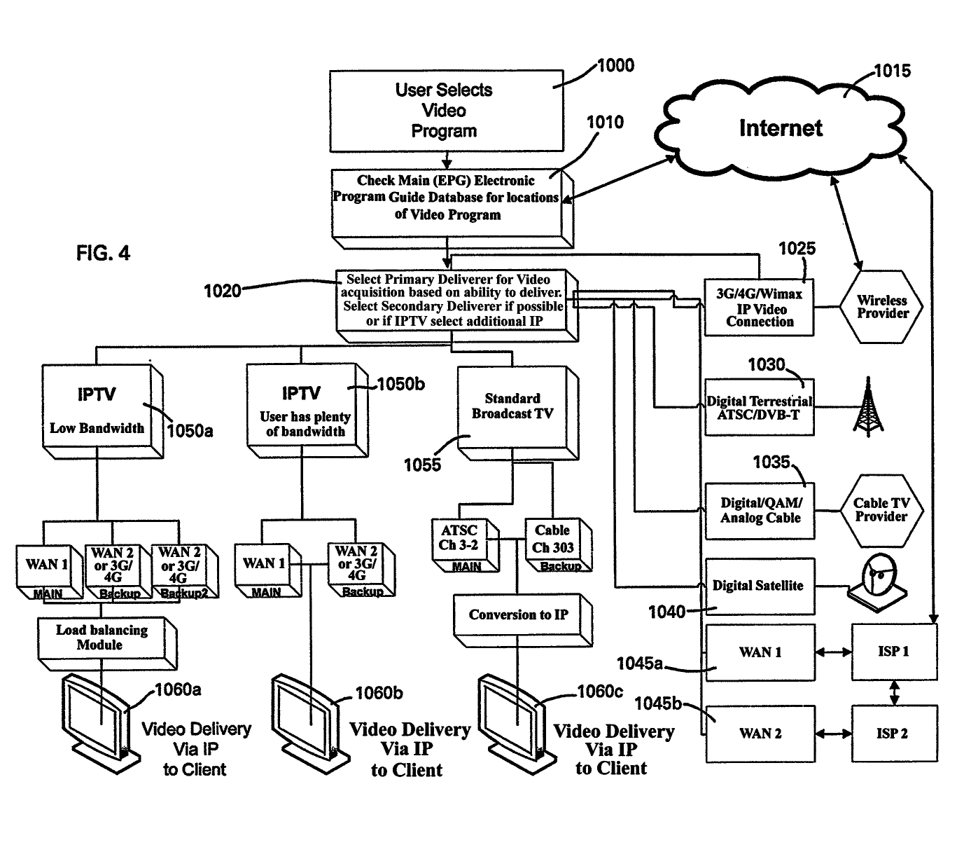

The router of the present invention includes correcting, or self-healing firmware to accommodate and adjust for signal disruption. FIG. 4 depicts a connectivity and logic decision schematic of the router of the present invention within a WAN/LAN configuration. Router 400 sends a test signal 405 to status the Wide Area Network. This initiates a ping-type packet 410 to be sent to the system server 415. Receipt or acknowledgement 420 of the ping-type pack is returned by server 415. As noted in Decision Box A, if the ping-type packet is properly received 425, and acknowledgement verified, then nothing further need be done, insomuch as this portion of the communication is properly functioning. If, however, the ping-type packet is not properly received, and acknowledgement from server 415 is not available, a report 430 is issued. The test ping-pack is then resent 435 to server 415, and an acknowledgement is again solicited. The logic flow for this sequence is illustrated within Decision Box B. This procedure is performed a limited number of times by a WAN set counter 440, preferably M=2 times, although the exact number of test initiations is arbitrary but generally quite few. If router 400 fails to receive a proper acknowledgement within the predetermined number of test initiations, a reset signal 445 is initiated for router 400. Upon a reset command 450, as indicated within Decision Box C, WAN set counter 440 is reset to zero (M=0), a message is sent to the network that router 400 is rebooting, and a router reboot 455 is initiated.

In a similar fashion, router 400 also tests the Local Area Network communications. Router 400 sends a test signal 505 to status the Local Area Network. This initiates a ping-type packet 510 to be sent to devices 515 on the local area network. Receipt or acknowledgement 520 of the ping-type pack is returned by LAN devices 515. As noted in Decision Box D, if the ping-type packet is properly received 525, and acknowledgement verified, then nothing further need be done, insomuch as this portion of the communication is properly functioning. If, however, the ping-type packet is not properly received, and acknowledgement from LAN devices 515 is not available, a report 530 is issued. The test ping-pack is then resent 535 to LAN devices 515, and an acknowledgement is again solicited. The logic flow for this sequence is illustrated within Decision Box E. This procedure is performed a limited number of times by a LAN set counter 540, preferably N=2 times, although the exact number of test initiations is arbitrary but generally quite few. If router 400 fails to receive a proper acknowledgement within the predetermined number of test initiations, a reset signal 545 is initiated for router 400. Upon a reset command 450, as indicated within Decision Box C, LAN set counter 540 is reset to zero (N=0), a message is sent to the network that router 400 is rebooting, and a router reboot 455 is initiated.

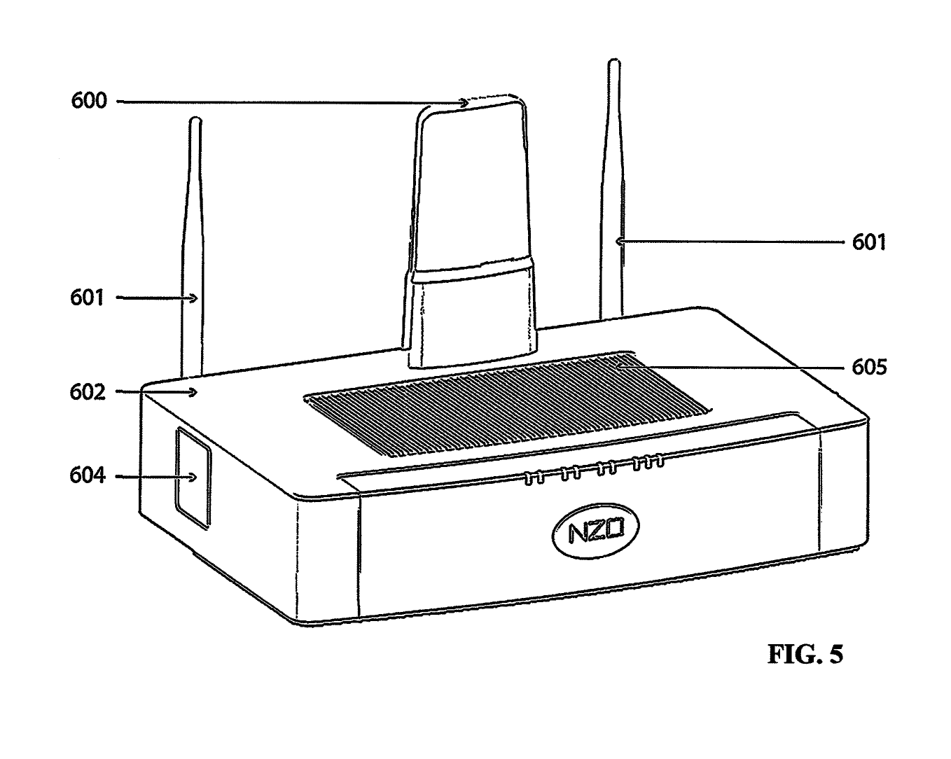

FIG. 5 depicts the router of the present invention with wireless and digital terrestrial antennas mounted therein. An integrated amplified digital terrestrial antenna 600 in its casing is shown attached to the router enclosure upper casing 602, flanked on either side, or both sides, by wireless antennas 601. Depicted on router enclosure upper casing 602 is an integrated heat sink 605 utilized for thermal management of the internal electronics. Preferably, on at least one side of router enclosure upper casing 602 is a removable panel 604 (protective covering) for accessing a port or multiple ports for USB, 3G, 4G, WiMax modem, and the like.

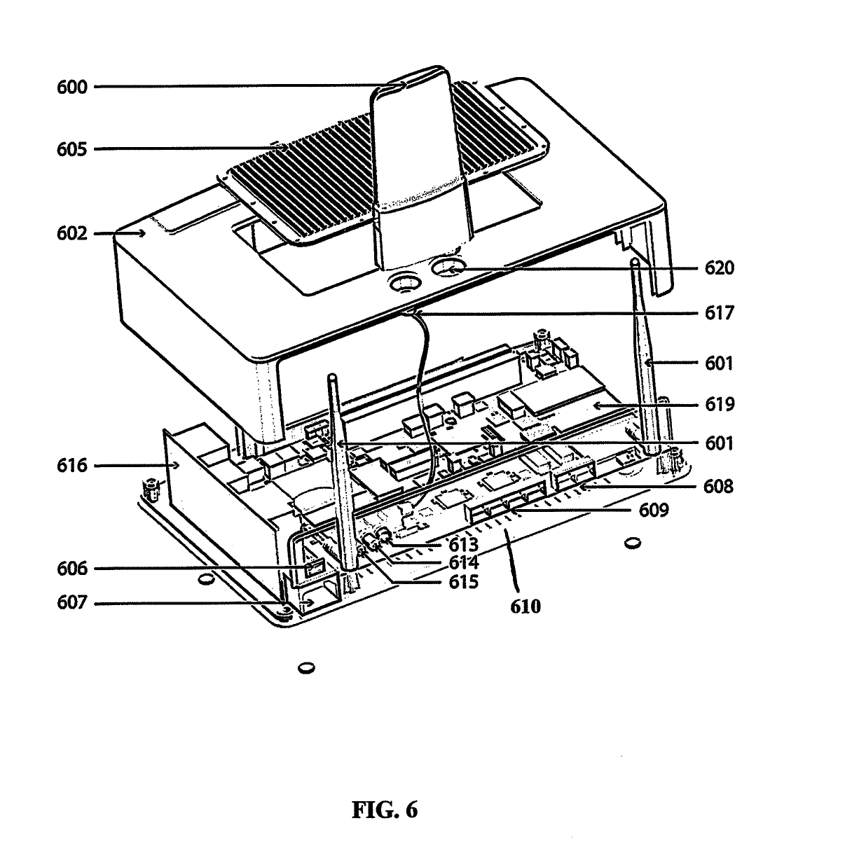

FIG. 6 depicts a perspective exploded view of the backside of the router of FIG. 5. Digital terrestrial antenna 600 is electrically connected to at least one amplifier power output 617. Antenna 600 is secured to router enclosure upper casing 602 via mounting configuration 620. Attached to the enclosure rear panel/base plate 610 are ports for signal transmission. Port 613 is an electrical connector for receiving signals from an external digital terrestrial antenna. Ports 614, 615 are electrical connectors for receiving external DVB-S2 satellite antenna. Two WAN inputs 608 are shown attached to enclosure rear panel/base plate 610, although any number of inputs may be implemented and accommodated by the router design. Multiple LAN outputs 609 are presented on the enclosure rear panel/base plate 610. The router is preferably configured with a 110/220 V internal power supply 616. An AC mains power port 607 connects external power to internal power supply 616 and is responsive to a user operated power switch 606. A removable battery cover 611 allows a user to access and interchange the battery.

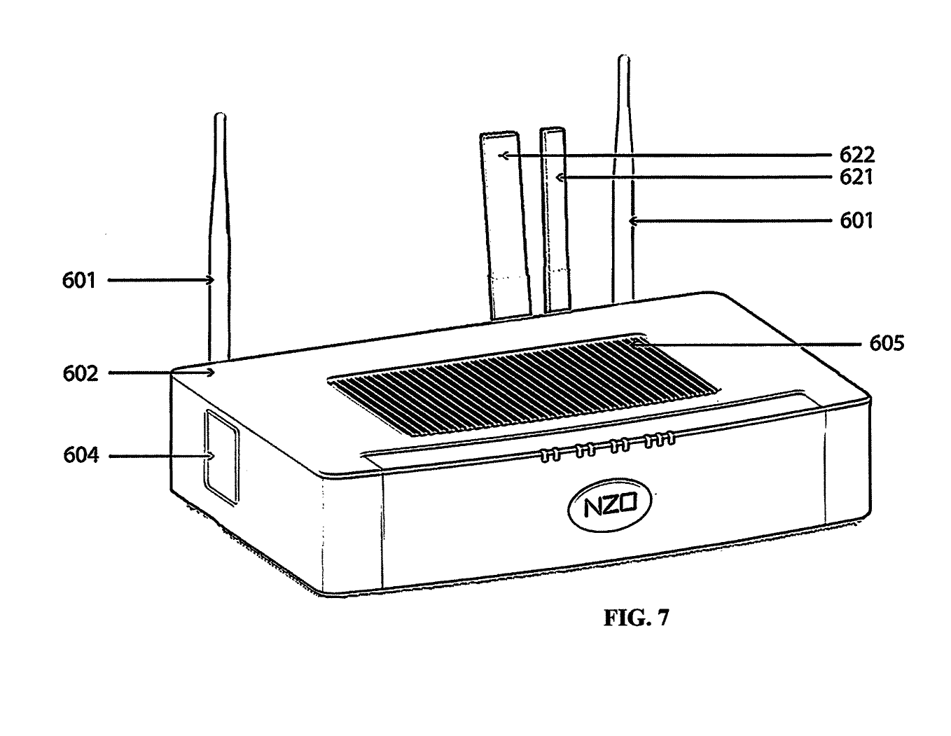

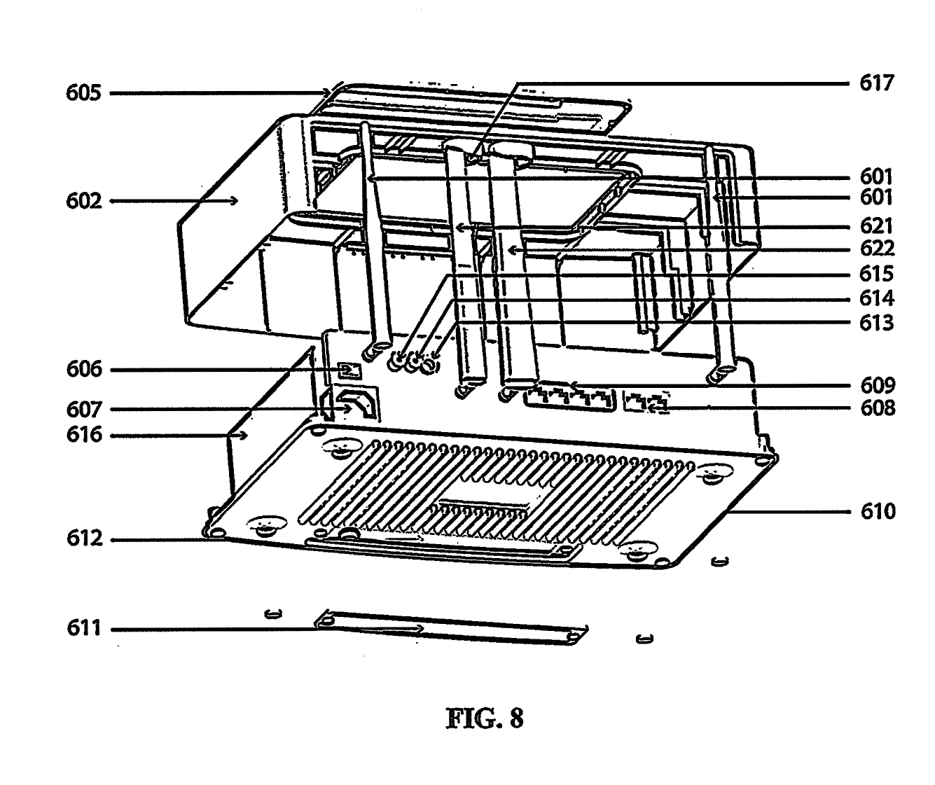

FIG. 7 depicts an optional embodiment of the present invention that incorporates board integrated amplified digital terrestrial antennas for UHF 621 and VHF 622. FIG. 8 is a perspective exploded view of the backside of the router of FIG. 7.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A router for simultaneously receiving and routing internet, satellite, 3G, 4G, and cable signal transmissions, comprising:
a first antenna embedded within said router, designed to receive and be in communication with digital terrestrial TV signal transmissions;
at least one second antenna embedded within said router, designed to receive and be in communication with wireless internet source transmissions;
an electrical or optical cable interface designed to receive and be in communication with cable TV signal transmissions;
a wireless or electrical cable interface designed to receive and be in communication with satellite signal transmissions;
a broadband modem for receiving and being in communication with DSL and cable transmission signals;
an electrical interface for receiving and being in communication with satellite internet signal transmissions;
a processor for determining the quality of each signal received by said router, selecting a highest quality signal, and allowing for the transmission of said highest quality signal to a client requesting said signal;
a plurality of embedded Local Area Network communication devices for transmitting routed signals to end users; and
an embedded wireless transmission device for transmitting routed signals to end users.

2. The router of claim 1 including:
a first signal multiplier for receiving and multiplying said cable TV transmission signal into N₁ cable TV transmission signals;
a first set of decoders corresponding to and in electrical communication with said N₁ cable TV transmission signals;
a second signal multiplier for receiving and multiplying said satellite transmission signal into N₂ digital satellite TV transmission signals;
a second set of decoders corresponding to and in electrical communication with said N₂ digital satellite TV transmission signals;
a third signal multiplier for receiving and multiplying said digital terrestrial TV signal transmissions into N₃ digital TV terrestrial signals;
a third set of decoders corresponding to and in electrical communication with said N₃ digital terrestrial signals; and
an IP Decoder Interface Manager in electrical communication with an output of each decoder in said first, second, and third sets of decoders.

3. The router of claim 1 wherein said wireless internet source transmissions include WiMax, 3G, and 4G, or any combination thereof.

4. The router of claim 3 wherein said at least one second antenna includes embedded antennas for receiving signal transmissions in WiMax, 3G, and 4G, or any combination thereof.

5. The router of claim 1 including an internal power supply designed and adapted to receive power via a signal transmission path, said internal power transmitted to an embedded antenna.

6. The router of claim 1 including solar panels attached to at least one side of an enclosure of said router, said solar panels in electrical communication with a battery and UPS circuit within said router enclosure, to charge said battery and ensure power to said router during electrical outage conditions.

7. The router of claim 2 wherein said multiplexors and decoders are designed to multiply and decode, respectively, multiple media transport streams, including ATSC, Clear QAM, DVB-T, DVB-T2, DVB-S, DVB-S2, DVB-C, DVB-C2, ISDB, analog cable, worldwide analog TV, and IPTV, or any combination thereof.

8. The router of claim 2 including embedded electronics for wide area network interfacing comprising a cable modem, DSL modem, WiMax modem, satellite modem, and high speed mobile 3G/4G modem, or any combination thereof.

9. A transmission signal routing system for a client/server configuration comprising:
a router;
at least one server device in communication with said router;
a plurality of client devices in communication with said at least one server device or said router;
wherein said router simultaneously receives and routes internet, satellite, and cable signal transmissions, said router in direct communication with at least one server device;
said at least one server device configured to manage transactions and communications with a plurality of client devices;
said router comprising:
a first antenna embedded within said router, designed to receive and be in communication with digital terrestrial signal transmissions;
at least one second antenna embedded within said router, designed to receive and be in communication with wireless internet source transmissions;
an electrical or optical cable interface designed to receive and be in communication with cable TV signal transmissions;
a wireless or electrical cable interface designed to receive and be in communication with satellite signal transmissions;
a broadband modem for receiving and being in communication with ADSL and cable transmission signals;
a processor for determining the quality of each signal received by said router, selecting a highest quality signal, and allowing for the transmission of said highest quality signal to a client requesting said signal;
a plurality of embedded Local Area Network communication devices for transmitting routed signals to said at least one server device and some or all of said plurality of client devices, or any combination thereof; and
an embedded wireless transmission device for transmitting routed signals to said at least one server device and some or all of said plurality of client devices, or any combination thereof.

10. The transmission signal routing system of claim 9 wherein said router directs media transport streams directly to said at least one server device or multi-server device.

11. The transmission signal routing system of claim 9 wherein said router and said at least one server device include:
a first signal multiplier for receiving and multiplying said cable TV transmission signal into N₁ cable TV transmission signals;
a first set of decoders corresponding to and in electrical communication with said N₁ cable TV transmission signals;
a second signal multiplier for receiving and multiplying said satellite transmission signal into N₂ satellite transmission signals;
a second set of decoders corresponding to and in electrical communication with said N₂ satellite transmission signals;
a third signal multiplier for receiving and multiplying said digital terrestrial signal transmissions into N₃ digital terrestrial signals;
a third set of decoders corresponding to and in electrical communication with said N₃ digital terrestrial signals;
an IP Decoder Interface Manager in electrical communication with an output of each decoder in said first, second, and third sets of decoders;

12. A method of receiving and routing transmission signals comprising:
simultaneously receiving digital terrestrial signal transmissions, wireless interne source transmissions, cable TV signal transmissions, satellite signal transmissions, and 3G/4G, or any combination thereof, in a single router device:
determining the quality of each signal received;
selecting a highest quality signal for each channel, function, or media, or any combination thereof, selected by an end user; and
transmitting said highest quality signal, from said simultaneous reception of multiple transmission sources, to said end user requesting said channel, said transmitting performed by sending said end user said highest quality signal via embedded Local Area Network communication devices or via embedded wireless transmission devices.

13. The method of claim 12 including:
multiplying said digital terrestrial signal transmissions, wireless internet source transmissions, cable TV signal transmissions, and satellite signal transmissions, or any combination thereof, each into a plurality of signal sets;
sending said plurality of signal sets to individual decoders corresponding to individual signals of said plurality of signal sets;
managing outputs of each of said individual decoders using an IP Decoder Interface Manager, said IP Decoder Interface Manager responsive to the selection of said highest quality signal for each channel selected by an end user; and
transmitting said highest quality signal for each channel selected by an end user via said embedded Local Area Network communication devices or via said embedded wireless transmission devices.

14. The method of claim 13 including continuously determining said quality of each of said signals received while said highest quality signal for each channel selected by an end user is being transmitted, and seamlessly substituting a new highest quality signal for a previous highest quality signal to said end user without interruption of said signal.

15. The method of claim 14 including synchronizing said signals received using a real time master clock in said router such that said new highest quality signal to be sent to said end user is seamlessly substituted for said previous highest quality signal sent to said end user.

16. The method of claim 13 including transmitting a stream of data from said digital terrestrial signal transmissions, wireless internet source transmissions, cable TV signal transmissions, and satellite signal transmissions, or any combination thereof, through multipliers and decoders, to an end user without compression of said signals.

17. The method of claim 16 including transmitting multiple media transport streams, including ATSC, Clear QAM, DVB-T, DVB-T2, DVB-S, DVB-S2, DVB-C, DVB-C2, ISDB, analog cable, worldwide analog TV, and IPTV, or any combination thereof.

18. The method of claim 16 including tuning said router to a transponder via an antenna link and acquiring a transport stream from said antenna link.

19. The method of claim 16 including transmitting packet data of video. audio, and data signals to end users.

20. The method of claim 12 wherein said wireless internet source transmissions include: WiMax, 3G, and 4G, or any combination thereof.

21. The method of claim 14 including operating in a client/server configuration, where transmission of said signals includes transmitting to a server device and a plurality of client/server devices in electrical or wireless communication with said server device.

22. A method for addressing signal integrity of a router connected to a network, said method comprising:
initiating an area network status test by sending a ping-type data packet to at least one receiving device;
checking for acknowledgement of said ping-type data packet from said at least one receiving device;
reporting if said acknowledgement is not received;
setting at least one counter of no acknowledgement;
re-initiating said status test by resending said ping-type data packet to said at least one receiving device; and
if said at least one counter exceeds a predetermined limit of receiving no acknowledgement, initiating a self-reboot of said router and resetting said at least one counter to zero.

23. The method of claim 22 wherein said network comprises a wide area network, a local area network, or both.

24. The method of claim 23 wherein said at least one counter includes a first counter for counting reports of no acknowledgement from a wide area network test status signal, and a second counter for counting reports of no acknowledgement from a local area network test status signal.

25. The method of claim 22 wherein said at least one receiving device includes a server for wide area network communications, local area network end user devices for local area network communications, or both.
